(19) United States
(12) Patent Application Publication
(10) Pub. No.: US 2011/0016503 A1
(43) Pub. Date: Jan. 20, 2011

(54) SYSTEMS AND METHODS FOR MANAGING CONTENT IN REAL-TIME

(76) Inventors: Germar Schaefer, Monument, CO (US); Charles Edward Ergen, Cheseaux (CH)

Correspondence Address: MERCHANT & GOULD PC, P.O. BOX 2903, MINNEAPOLIS, MN, 55402-0903, US

(21) Appl. No.: 12/837,077

(22) Filed: Jul. 15, 2010

Related U.S. Application Data
(60) Provisional application No. 61/226,163, filed on Jul. 16, 2009.
(60) Provisional application No. 61/226,136, filed on Jul. 16, 2009.

(51) Int. Cl. H04N 7/173

(52) U.S. Cl. 725/115

(57) ABSTRACT

Systems and methods are disclosed to facilitate the reception, processing, outputting, and communication of content from one or more sources. Content is stored on a digital video recorder device and a content storage server. The digital video recorder device exchanges metadata with the content storage server that indicates the specific content stored on the digital video recorder device. A communication device may request access to the content stored on the content storage server. The content storage server determines if the communication device is associated with a digital video recorder device that is storing the requested content. If the communication device is associated with a digital video recorder device storing the requested content, the content storage server sends the requested content stored on the content storage server to the communication device.

### CROSS-REFERENCE TO RELATED CASES

This patent application claims the benefit of U.S. Provisional Patent Application No. 61/226,163, filed on Jul. 16, 2009, entitled “SYSTEM AND METHODS FOR MANAGING CONTENT IN REAL-TIME”, and U.S. Provisional Patent Application No. 61/226,136, filed on Jul. 16, 2009, entitled “SYSTEM AND METHODS FOR MANAGING CONTENT”, both of which are hereby incorporated by reference in their entirety.

### BACKGROUND

Placeshifting devices, such as the Slingbox®, manufactured by Sling Media, Inc. of Foster City, Calif., allow a user to remotely access their video content from their home. The Slingbox attaches to a user's satellite or cable television receiver or digital video recorder (DVR) and transmits content to an Internet connected device, such as a laptop, mobile telephone or the like. For example, a user can record a movie onto the DVR and then remotely access the movie via their laptop while traveling away from their home. However, the ability to access such stored content can be impacted by many factors, such as a power failure at the home, an outage of the network connection to the home, a failure of the physical device attached to the Slingbox and the like. Thus, the user may be unable to remotely access their content at the desired time. Even if the user is able to access their DVR via the Slingbox device, the bandwidth between the Slingbox and the Internet may be limited, negatively impacting the quality of the video transmitted therebetween.

### SUMMARY

Embodiments of the present disclosure relate to apparatus, systems and methods which facilitate the communication of content from one or more sources. In embodiments, content is stored at a digital video recorder and a content storage server. A communication device may request content from the content storage server. In such embodiments, the content storage server provides access to the communication device if the communication device is associated with a digital video recorder that has stored the requested content. If the communications device is granted access, the communication server may send the requested content to the communications device.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 illustrates an embodiment of a communication system 100.

FIG. 2 illustrates an embodiment of a data flow chart 200 for the communication system of FIG. 1.

FIG. 3 illustrates an embodiment of a DVR 106A of FIG. 1.

FIG. 4 illustrates an embodiment of a content storage server 110A of FIG. 1.

FIG. 5 illustrates an embodiment of a process 500 for controlling access to stored content.

FIG. 6 illustrates an embodiment of a process 600 for synchronizing metadata between a network storage device and a DVR.

FIG. 7 illustrates an embodiment of a computer environment and computer system 700 for managing content.

### DETAILED DESCRIPTION

The various embodiments described herein generally provide apparatus, systems and methods which facilitate the reception, processing, outputting and communication of content from one or more sources, via one or more communications mediums (or networks), to one or more communication devices for presentation to one or more end-users. More particularly, described herein are embodiments for storing content at multiple locations such that a user can access recorded content anywhere via an Internet connection. Content may be stored on a user's physical DVR, e.g., in their home. Additionally, the same content may be stored in a central network location accessible by multiple users. In embodiments described herein, access rights to content stored in the multiple locations are controlled through the synchronization of metadata associated with the stored content. Thus, the user can access their recorded content through a physical DVR within their home or from a central location.

In at least one embodiment, a system includes a DVR that may be located in a user's home, office, business or other location. The DVR receives programming from a broadcast infrastructure (e.g., cable, satellite or Internet protocol television (IPTV)) and stores selected portions of the incoming programming for subsequent viewing as requested by the user. The system also includes a network storage device, such as a content storage server, that stores content associated with a plurality of users. For example, the content storage server may store all incoming programs corresponding with one or more channels associated with the broadcast infrastructure.

The DVR and the content storage server periodically exchange metadata indicating content for which the user is entitled to access. For example, the metadata may indicate particular content that is stored by the DVR. A user may then connect to the content storage server to access content stored thereupon using a communication device, such as a computer, mobile telephone or the like. The content storage server utilizes the metadata to determine which of the programming stored on the server that the user is entitled to access. Responsive to authenticating a user's ability to access particular stored programming, the content storage server streams the content to the communication device, allowing the user to remotely access content without connecting their communication device to the DVR in their home.

In other words, the content storage device stores a wide variety of content, not all of which a particular user is entitled to access. The content storage server stores the metadata identifying the content stored on the user's personal DVR or otherwise identifying the selected portions of stored content that the user is entitled to access. The user may then connect to the content storage device rather than their personal DVR to access content and the content storage device allows the user to access any content for which they could access via their personal DVR.

For example, the user could access content through the content storage device from anywhere in the world when their personal DVR is broken or when there is an outage of the Internet connection to the home. Access by the user to the content storage device may also be utilized to leverage a higher bandwidth connection for transferring the video if the Internet connection to the user's personal DVR is inadequate for the desired connection.

Metadata may be exchanged between the DVR and the content storage device unidirectionally or bidirectionally depending on desired design criteria. For example, the DVR may periodically transmit metadata to the content storage device describing the content stored on the DVR, content to be recorded by the DVR and/or other content that the user is entitled to access. Examples of exchanged metadata include program names, program identifiers, event ids used in timers, event ids used in spontaneous recordings, event ids of deleted events and the like. It is to be appreciated that any type of identifying data may be used to identify programs that a user is entitled to access. In some embodiments, the metadata may include bookmarks and similar data, such as pointers where to resume watching a particular program and the like. Thus, as new content is stored on the DVR and/or when content is deleted from the DVR, the associated metadata is transmitted to the content storage server. In one embodiment, the content storage server then utilizes the metadata to provide the user with a virtual image of the user's personal DVR. This allows the user to access their same content stored on the DVR from the content storage device via a network connected communication device.

Metadata may also include control information such as a user command to start, stop, pause, rewind, fast-forward, or to utilize any other function of the content. In such embodiments, the metadata representing control information may be generated and sent to the content storage server upon receipt of the user command. The control information stored in the metadata may be used to recreate the user viewing experience as the user views content across devices. Metadata may also include personalized information such as, user location, a protection date for the content, a delete date for the content, and metadata related to commercials. In such embodiments, the personalization metadata may be used to personalize a user's experience, for example, by personalizing advertising to a user or presenting advertising (e.g., commercials) to a user based upon a user's current location.

In at least one embodiment, the metadata is exchanged between the DVR according to a pre-determined schedule. In at least one embodiment, metadata is exchanged in real-time or substantially real-time. In other words, as changes are made to the content stored on the DVR, e.g., additions or deletions, the DVR responsively transmits update messages to the content storage server regarding the content modification. Thus, the content storage server presents the virtual image of the DVR to the user in real-time.

In at least one embodiment, a user requests modifications to their stored content via the content storage server. For example, a user may request to delete content or set a new recording timer by providing input through their communication device to the content storage server. The content storage server responsively transmits an update message to the DVR and the DVR processes the message accordingly to synchronize with the content storage server. For example, the DVR may delete a recording responsive to a delete request received from the content storage device.

Those of skill in the art will also appreciate that the content described herein may be comprised of television broadcasting or other forms of data. For example, the embodiments disclosed herein may work with audio content (e.g., music or radio broadcasts), video games, data, or other forms of content.

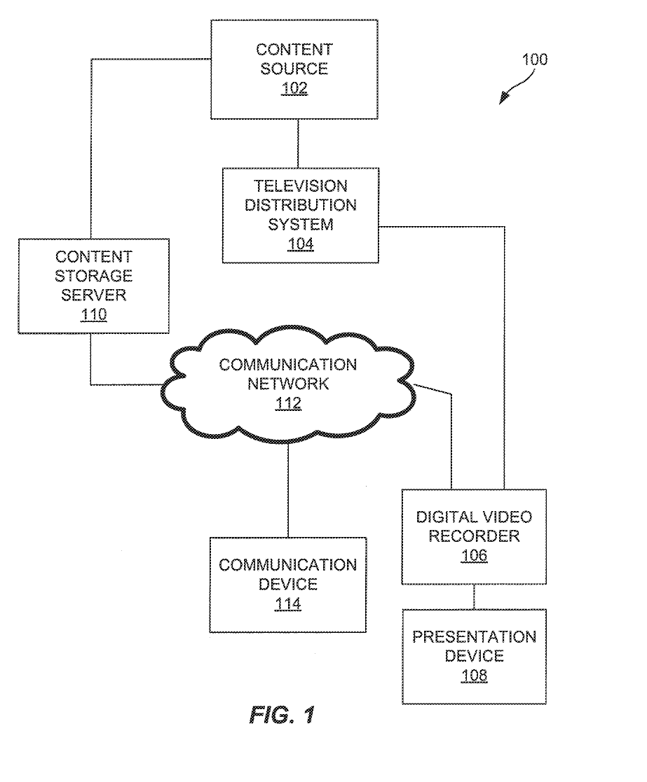

FIG. 1 illustrates an embodiment of a communication system 100. The communication system 100 includes a content source 102, a television distribution system 104, a DVR 106, a presentation device 108, a content storage server 110, a communication network 112 and a communication device 114. Each of these components is described in greater detail below. The communication system 100 may include other components, elements or devices not illustrated for the sake of brevity.

The content source 102 is operable for receiving and/or generating content for communication via the television distribution system 104 to one or more television receivers, e.g., DVR 106. The content to be received, processed, outputted and/or communicated may come in any of various forms including, but not limited to, audio, video, data, information, or otherwise. Exemplary content sources 102 include over-the-air (OTA) terrestrial transmission facilities, cable television distribution head-ends, satellite television uplink centers, broadband, cellular, Internet servers, or other wireless facilities and the like.

The television distribution system 104 is operable to transmit content from the content source 102 to the DVR 106 and/or other types of television and television receiving devices (e.g., cable, satellite, cellular and other wireless receiving devices, and/or IPTV set-top boxes). The television distribution system 104 may comprise any type of wired (e.g., cable and fiber) and/or wireless (e.g., cellular, satellite, microwave, and other types of radio frequency) communication medium and any desired network topology (or topologies when multiple mediums are utilized). Exemplary television distribution systems 104 include terrestrial, cable, satellite and Internet protocol television (IPTV) distribution systems. In at least one embodiment, the television distribution system 104 broadcasts or multicasts content to a plurality of television receivers, e.g., the DVR 106. The television distribution system 104 may also distribute content to a specific addressable television receiver, e.g., DVR 106, such as video-on-demand and the like. In at least one embodiment, the content source 102 may be embodied as a transmission facility of the television distribution system 104.

While the present disclosure describes embodiments that include a DVR preferably taking the form of a set-top box DVR device, one of skill in the art will appreciate that devices other than a set-top box DVR device may be employed within the systems and methods disclosed herein. For example, any DVR device capable of receiving content, recording content, receiving user commands, creating metadata, and communicating with a content storage server may be employed within the embodiments of the present disclosure. Examples of such devices include, but are not limited to, personal computers, laptops, mobile devices (e.g., cell phones, smart phones, etc.), televisions, and the like. In further embodiments, the capabilities of the DVR discussed herein may be performed by multiple devices. For example, a distributed DVR may be employed with embodiments of the present disclosure such that the functionality of the DVR is performed by multiple devices. One of skill in the art will appreciate that any such device or devices may be employed in place of a set-top box DVR device in the present disclosure.

The DVR 106 is operable to receive content from the television distribution system 104 and store the received content for subsequent presentation to a user. The DVR 106 is further operable to output the received and/or stored content for presentation by the presentation device 108. In at least one embodiment, the presentation device 108 is a display device (e.g., a television) configured to display content to a user. In another embodiment, not shown, the presentation device may be integrated with the DVR (e.g., a mobile phone operable to receive, store, and display content from the television distribution system 104). The DVR 106 may receive an audio/video stream in any format (e.g., analog or digital format), and store and output the audio/video stream for presentation by the presentation device 108. In at least one embodiment, the DVR 106 may be integrated with a television receiver, such as a satellite, cable, over-the-air, broadband or other type of television receiver that receives and demodulates television signals that are outputted for display on a display device (e.g., a television). As used herein, a television receiver or DVR may also be referred to in some embodiments as a set-top box, which is a television receiver that is located externally with respect to a display device. The DVR 106 may be further configured to output menus and other information that allow a user to control the output of audio/video content by the DVR 106, view electronic programming guides (EPGs), set recording timers and the like. In some embodiments, the DVR 106 and the presentation device 108 may be integrated as a device combining the functionality of a display device and television receiver/DVR or the like.

Responsive to particular recording timers, the DVR 106 may coordinate the reception of video signals associated with a television program through a television receiving resource (e.g., a television tuner) and storage of the video signals onto a storage medium (e.g., a hard drive or Flash memory). The DVR 106 may include any number of television receiving resources utilized for receiving television programs. A DVR 106 minimally includes at least one television receiving resource to receive and record video signals associated with a television program. The DVR 106 may include multiple television receiving resources to record multiple television programs simultaneously. For example, the DVR 106 may include two or more tuners that allow recording and/or viewing of multiple programs though the DVR 106 simultaneously. In at least one embodiment, the DVR 106 may include multiple types of television receiving resources, such as an over-the-air (OTA) tuner and a satellite and/or cable television tuner that may be utilized to receive and/or record programs from multiple sources.

The content storage server 110 is operable to receive content from the content source 102 (or optionally the television distribution system 104) and store the received content for subsequent viewing by users. In at least one embodiment, the content storage server 110 is operable to store incoming content associated with one or more linear channels. In other words, the content storage server 110 stores each program broadcast on a channel through the television distribution system 104. In some embodiments, the content storage server 110 stores selected portions of the incoming content. For example, the content storage server 110 may store particular programs that have been selected for recording by one or more of the users associated with the content storage server 110.

In at least one embodiment, the content storage server 110 receives content from the content source 102 in the same format as transmitted from the content source 102 to television distribution system 104. For example, video content may be transmitted from the content source 102 to the content storage server 110 over an Internet connection and/or the like. In at least one embodiment, the content storage server 110 may alternatively receive content from the television distribution system 104 rather than directly from the content source 102. For example, the content storage server 110 includes a separate television receiving resource, e.g., a tuner, for each channel from which it records content. In at least one embodiment, the content storage server 110 may be configured to periodically delete content that is not associated with any users.

As a user interacts with the DVR 106, the DVR generates metadata describing content stored on the DVR 106. For example, a user may request the DVR to record various television programs and the DVR 106 may generate metadata regarding the recording timer and/or the content stored responsive to the recording requests. The metadata is periodically transmitted from the DVR 106 to the content storage server 110 through the communication network 112. The content storage server 110 processes the metadata to determine which content stored within the content storage server for which the user of the DVR 106 is entitled to access via the communication device 114. In other words, the content storage server 110 provides the user of the communication device 114 with a virtual image of the content stored on the DVR 106.

The communication network 112 is operable to communicatively couple the content storage server 110 with the DVR 106 and communicatively couple the communication device 114 with the content storage server 110 and/or the DVR 106. The communication network 112 may utilize any desired combination of wired (e.g., cable and fiber) and/or wireless (e.g., cellular, wireless, satellite, microwave, and radio frequency) communication mediums and any desired network topology (or topologies when multiple mediums are utilized). Exemplary communication networks include television distribution networks (e.g., satellite, cable, over the air (OTA) and Internet protocol television (IPTV) television networks), wireless communication networks, public switched telephone networks (PSTN) and local area networks (LAN) or wide area networks (WAN) providing data communication services.

While a single communication network is illustrated as coupling the content storage server 110, the DVR 106 and the communication device 114, it is to be appreciated that multiple discrete communication networks may also be utilized. For example, the content storage server 110 may be communicatively coupled to the DVR 106 through a first communication network, e.g., a television distribution network. The communication device 114 may be communicatively coupled to the content storage server 110 and/or the DVR 106 through a separate communication network, e.g., an Internet data network.

The communication device 114 is operable to connect to the content storage server 110 and/or the DVR 106 via the communication network 112 to receive content and the communication device 114 is operable to present the content to a user. The communication device 114 may comprise any type of device that provides communication services to a user. For example, the communication device 114 may be a mobile telephone that provides voice and data communication services to the user. In other embodiments, the communication device 114 may comprise a mobile device with a display screen that provides data communication services to the user, such as email, video, Internet browsing and the like. In at least one embodiment, the communication device 114 may be a mobile phone, laptop or computer. Other examples of communication device 114 include video game consoles, personal digital assistants (PDAs), and video playback devices (e.g., mobile DVD players, mobile televisions, Internet connected television receivers and the like).

In at least one embodiment, the communication device 114 connects to the DVR 106 to access content stored thereupon. The user selects content for viewing and the DVR 106 streams the selected content to the communication device 114 for presentation to the user. Similarly, the communication device 114 may connect to the content storage server 110. The content storage server 110 identifies and transmits to the communication device 114 programming that the user is entitled to access. The user may then select programming for viewing and the content storage server 110 is operable to stream the selected content to the communication device 114 for presentation to a user.

As described above, the content storage server 110 records a wide variety of programming from one or more channels. A user of the DVR 106 will not likely record all of the content on the DVR 106 that is stored by the content storage server 110. Thus, the content storage server 110 utilizes the metadata to determine which portion of the content stored thereupon that the user of the DVR 106 is entitled to access. In at least one embodiment, the user is entitled to access from the content storage server 110 any content stored on the DVR 106. In other words, the content storage server 110 outputs for presentation to the user of the communication device 114 a virtual image of the DVR 106.

In at least one embodiment, the content storage server 110 outputs for presentation to the user of the communication device 114 a virtual image of the DVR 106. For example, some content stored on the DVR 106 may not be stored on the content storage server 110. Thus, the user of the communication device 114 may be unable to access such content through the content storage server 110. In other embodiments, an operator or content provider may not desire to allow the communication device 114 to access all of the same content stored on the DVR 106 via the content storage server 110. For example, content may be territorially restricted and the content storage server 110 may restrict the user of the communication device 114 from accessing particular content depending on the physical location of communication device 114.

In at least one embodiment, the content storage server 110 may allow the user to access different content than what is physically stored on the DVR 106. For example, a user of the DVR 106 may initially record a certain program on the DVR 106, but may later desire to delete the program from the storage medium of the DVR 106. However, the user of the DVR 106 may select an option such that the program is physically deleted on the DVR 106, but the right to watch a recording of the program is retained. The DVR 106 transmits metadata to the content storage server specifying the user's access to the deleted programming. Thus, when the user accesses the content storage server 110 using the communication device 114, the user will have the option to watch the programming which was deleted from the DVR 106.

As described above, a user may be presented with many different options for maintaining data on the DVR or like devices and the content storage server. In one embodiment, a user may have the option to store the content on both the DVR and the content storage server. In another embodiment, the user may be given the option to hibernate the content, that is, the user may select to delete a local copy of the content on the DVR or like device; however, the content may be maintained on the content storage server for later access by the user. In yet another embodiment, the user may be given the option to delete the content. In such embodiments, the content may be deleted or hidden from the DVR or like device, the content may be permanently deleted from just the content storage server, or the content may be deleted from all devices and servers. One of skill in the art will appreciate that content may be deleted in many different ways. For example, the content may be physically deleted from storage or a pointer or reference to the content may be dereferenced such that the user no longer has access to the storage area containing the content.

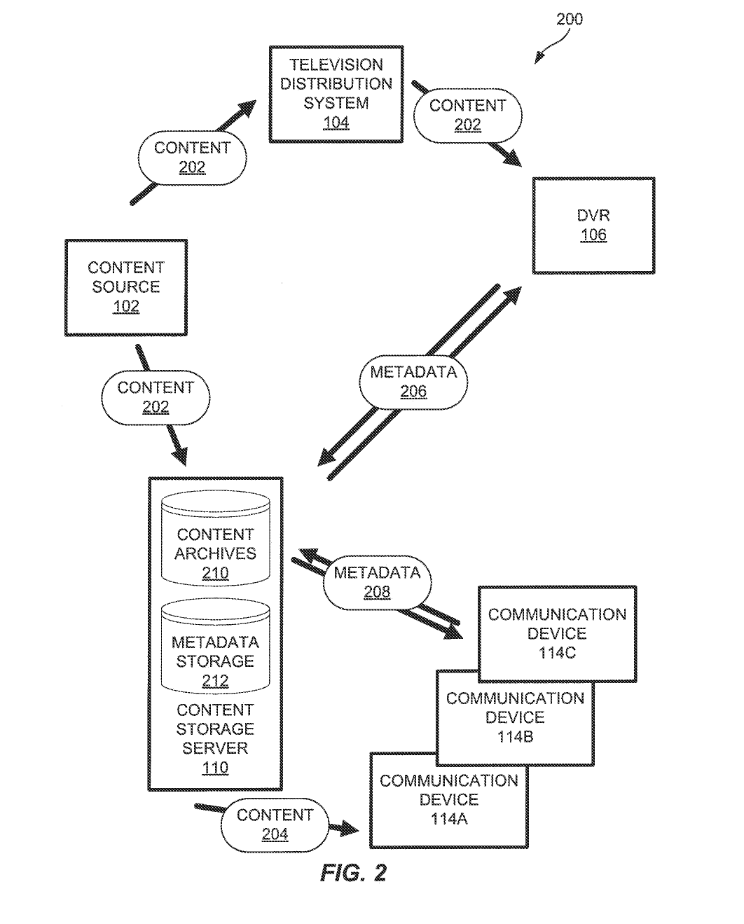

FIG. 2 illustrates an embodiment of a data flow chart 200 for the communication system 100 of FIG. 1. FIG. 2 will be described in reference to the communication system 100. The data flow chart may include other communications not illustrated for the sake of brevity.

The content 202 originates at the content source 102. The content source 102 distributes the content 202 to the television distribution system 104 and to the content storage server 110. The television distribution system 104 distributes the content 202 to the DVR 106 and the DVR 106 records the content for subsequent viewing by a user.

As illustrated in FIG. 2, the content storage server 110 includes a content archive 210 and metadata storage 212. The content archive 210 stores the content 202 received from the content source 102. Various communication devices 114A-114C access the content storage server 110 and request to access portions of the content archive 210. The content storage server 110 responsively provides streaming content 204 over an Internet connection or other data connection to the communication devices 114A-114C. Although the example embodiment illustrated in FIG. 2 depicts three communication devices 114A-114C, one of skill in the art will appreciate that any number of communication devices may be employed with the embodiments of the present disclosure.

The metadata storage 212 stores various metadata generated by the content storage server 110, as well as metadata 206 and/or 208 received from the DVR 106 and/or the communication devices 114A-114C. For example, the DVR 106 may exchange metadata 206 with the content storage server 110 identifying content stored on the DVR 106. The content storage server 110 utilizes the metadata 206 to determine what content to allow the communication devices 114A-114C to access from the content archive 210.

In embodiments, the content storage server 110 records all content that it receives from the content provider or that is transmitted within the television distribution system. In another embodiment, the content storage server 110 records content upon receiving metadata indicating that at least one user has selected to record the content. In this embodiment, the content storage server may store a physical copy of the content to be recorded by a user's DVR 106 or like device. For example, the content storage server 110 may receive metadata from a user's DVR 106 that indicates future or scheduled recordings to be made by the user's DVR 106. In this example, the content storage server 110 may then store a copy of content based upon the received metadata that indicates the future or scheduled recording. In another embodiment, the content storage server 110 may save a global copy of content for all or a subset of users of the television distribution system. For example, the content storage server 110 may save a global copy of a content item and grant a user or a subset of users access to the content item if the user or subset of users have the appropriate access rights (e.g., the content item was first recorded at a user's DVR 106). In such embodiments, the content storage server may use the received metadata to create a logical copy of a user's DVR 106. For example, the content storage server 110 may provide a reference or a pointer within a user's profile to the global copy of a content item stored by the content storage server 110. In further embodiments, the content storage server 110 may conditionally record (e.g., cache) all content but may delete the content unless it receives metadata indicating that a user has recorded the content on their local DVR or like device. In such embodiments, the content storage server 110 may store the content for a predetermined time before deleting it in order to account for delays in receiving metadata 206 from the DVR 106 or like device.

The content storage server 110 also exchanges metadata with the communication devices 114A-114C. For example, users of the communication devices 114A-114C may request to modify the content associated with the user's account on the content storage server 110 and/or the DVR 106. In some embodiments, users of the communication devices 114A-114C may bookmark locations with the streaming content 204 for subsequent retrieval/viewing, either via the communication devices 114A-114C or via the DVR 106. As illustrated in FIG. 2, the content storage server 110 facilitates the synchronization of the metadata storage 212 with the DVR 106 and/or the communication devices 114A-114C, such that each device in the communication system 100 may identify what content a user is entitled to access.

In another embodiment, the content storage server 110 may perform translation of the content (e.g., content 202 and 204) received by the content storage server 110. In embodiments, the content storage server 110 may transmit content to various types of devices having different capabilities or supporting different formats. For example, the content received from the television distribution system 104 may have a different file format than is supported by a communication device, such as communication devices 114A-114C. In such embodiments, the content storage server 110 may be capable of performing translations between file formats (e.g., Windows Media Video, MPEG-1, Audio Layer 3, MPEG-2, MPEG-4 AVC (H.264), etc.), between different encryption formats, or between different compression schemes. In other embodiments, the content storage server 110 may perform content translations. For example, the content storage server may transmit only the video, data, or audio portions of content rather than transmitting the entire content as it is stored at the content storage server 110. As another example, the content storage server 110 may translate video content (e.g., video content stored using an MPEG-2 encoding format) and transmit an audio stream (e.g., by translating an audio portion of the video content into an audio stream that complies with a streaming format such as the Real-Time Streaming Protocol (RTSP) or QuickTime Streaming Server protocols). While such translations have been described as being performed by the content storage server 110, one of skill in the art will appreciate that the translation may be performed by other devices (shown and not shown in FIG. 2) such as, for example, a DVR or like devices, and/or the communication devices.

In additional embodiments, the format that the content is translated into may be based upon the metadata received by the content storage server 110. For example, the metadata may indicate the type of format that the user's communication device may support. In other embodiments, the metadata (e.g., metadata 206) may indicate a user's access rights to content (e.g., standard definition or high definition). For example, a user may have recorded a show in standard definition even though the user it entitled to high definition content. Based upon the user's access rights, e.g., as indicated by the received metadata 206, a user's profile, or as specified in a request received from a communication device, the content storage system may give the user access to high definition content, even though the user recorded a standard definition copy of the content at the user's DVR 106.

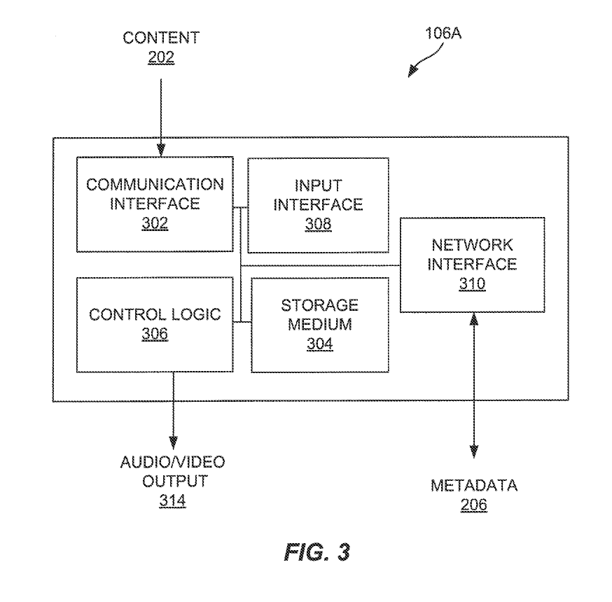

FIG. 3 illustrates an embodiment of a DVR 106A of FIG. 1. FIG. 3 will be discussed in reference to the communication system 100 illustrated in FIG. 1. The DVR 106A includes a communication interface 302, a storage medium 304, control logic 306, an input interface 308 and a network interface 310. Each of these components will be discussed in greater detail below. The DVR 106A may include other elements, components or devices which are not illustrated for the sake of brevity.

The communication interface 302 is operable to receive content 202 from the television distribution system 104. More particularly, in at least one embodiment, the communication interface 302 receives and tunes a television signal including television programming. The communication interface 302 may receive an over-the-air (OTA) broadcast, a direct broadcast satellite signal, a cable television signal or an IPTV signal and tune the content 202 to extract the selected television programming. In at least one embodiment, the communication interface 302 may comprise multiple tuners, utilized by the DVR 106A to output and/or record multiple television programs simultaneously.

The storage medium 304 is operable to persistently store video signals recorded by the DVR 106A. The storage medium 304 may comprise any type of non-volatile memory appropriate for storing video signals recorded by the DVR 106A. Exemplary storage mediums 304 include hard drives (e.g., magnetic memory), flash memory, battery backed up memory and the like. In at least one embodiment, the storage medium 304 may be internally located within the DVR 106A. In other embodiments, the storage medium 304 may be located external with respect to the DVR 106A. The DVR 106A may also utilize a combination of internal and external storage mediums 304 for storage of video signals.

The input interface 308 may be operable to wirelessly receive data from a remote control (not shown in FIG. 3). The input interface 308 may communicate with a remote control utilizing any type of IR or RF communication link. In at least one embodiment, the input interface 308 receives a key code from a remote control (not shown in the Figures) and responsively provides the key code to the control logic 306 for processing. In some embodiments, the input interface 308 may receive positional information from a scrolling device of the remote control, e.g., a touch pad, scroll wheel or the like. The data received from the remote control may be utilized by the control logic 306 to control the output of content by the control logic 306. Some of the data received by the input interface 308 may request to view electronic programming guide data, menus and the like.

The control logic 306 is operable to control the operation of the DVR 106A. The control logic 306 may be a single processing device or a plurality of processing devices that cooperatively operate to control the operation of the DVR 106A. The control logic 306 may include various components or modules for processing and outputting audio/video content. Exemplary components or modules for processing audio/video content include a demodulator, a decoder, a decompressor, a conditional access module and a transcoder module.

The control logic 306 coordinates storage of the content 202 onto the storage medium 304. More particularly, the control logic 306 operates responsive to recording timers configured on the DVR 106A to command the communication interface 302 to receive content from a specified channel and coordinates storage of the content onto the storage medium 304.

In at least one embodiment, the control logic 306 is operable to generate an audio/video output 314 based on the content 202, e.g., pass through the signal for display by an associated presentation device 108. The control logic 306 is also operable to retrieve stored video content from the storage medium 304 to generate an audio/video output 314 for display by the presentation device 108. The presentation device 108 then presents the audio/video output 314 to the user. The control logic 306 may incorporate circuitry to output the audio/video streams in any format recognizable by the presentation device 108, including composite video, component video, Digital Visual Interface (DVI), High-Definition Multimedia Interface (HDMI), 1394 and WiFi. The control logic 306 may also incorporate circuitry to support multiple types of these or other audio/video formats. In at least one embodiment, as described above, the DVR 106A may be integrated with the presentation device 108, and the control logic 306 may be operable to control the presentation of the audio/video output 314 by the presentation device 108.

To coordinate the storage of the content 202, the control logic 306 is operable to receive user input requesting to record one or more television programs. The control logic 306 responsively sets recording timers associated with the television programs. In some embodiments, the control logic 306 is further operable to output user interface menus and other information to allow the user to view the recording timers, modify recording timers and identify recording conflicts. Responsive to the recording timers, the control logic 306 coordinates the recording of the content 202 into a file of the storage medium 304.

The storage medium 304 is also operable to store metadata describing the audio/video content stored thereupon. For example, the storage medium 304 may be operable to store a list of programs stored thereupon and/or a list of recording timers set by a user and/or executed by the control logic. Periodically, the control logic 306 identifies portions of the metadata which are to be transmitted to external devices, such as the content storage server 110 (see FIG. 1).

The network interface 310 is connected to a communication network 112 (see FIG. 1) and may provide bi-directional or uni-directional data transmission between the DVR 106A and the content storage server 110 and/or the communication device 114. In at least one embodiment, the control logic 306 identifies metadata 206 for transmission and the network interface 310 initiates transmission of the metadata 206 to the content storage server 110 through the communication network 112. The network interface 310 may also transmit metadata and/or content to the communication device 114. For example, the communication device 114 may transmit a request to the network interface 310 for access to content stored on the storage medium 304. The control logic 306 may responsively initiate retrieval of the content from the storage medium 306 and transmission of the content to the communication device 114 through the network interface 310. In other words, the DVR 106A streams content to the communication device 114 via the network interface 310. In at least one embodiment, the network interface 310 is an Ethernet connection communicatively coupled to the Internet or other type of data communication network. It is to be appreciated that other types of wired and wireless connections may be utilized, such as WiFi, depending on desired design criteria.

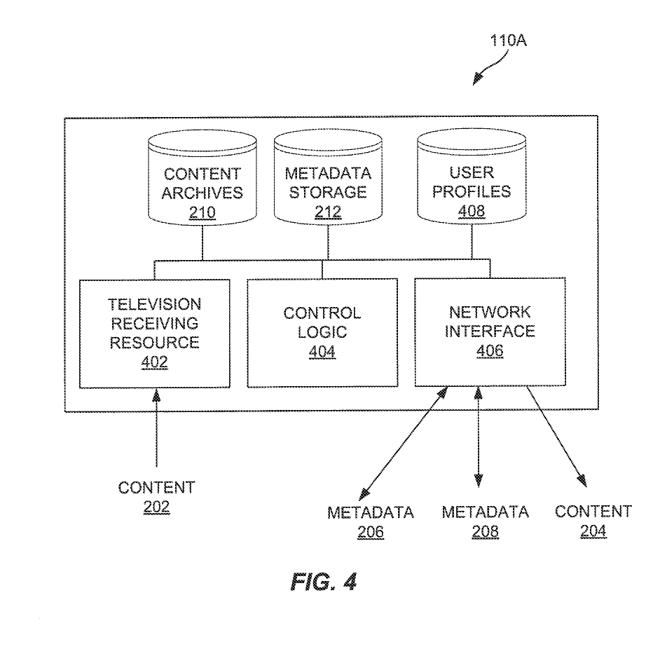

FIG. 4 illustrates an embodiment of a content storage server 110A of FIG. 1.

FIG. 4 will be discussed in reference to the communication system 100 illustrated in FIGS. 1 and 2. The content storage server 110A includes content archives 210, metadata storage 212, user profile storage 408, a television receiving resource 402, control logic 404 and a network interface 406. Each of these components is described in greater detail below. The content storage server 110A may include other components, elements or devices not illustrated for the sake of brevity.

The content storage server 110A includes various storage mediums for storing data utilized by other components of the content storage server 110A. As illustrated in FIG. 4, the content storage server 110A includes content archives 210, metadata storage 212 and user profiles storage 408. While each of these data storage collections is illustrated discretely in FIG. 4, it is to be appreciated that they may be combined into one or more physical storage mediums, depending on desired design criteria. Further, any of the content archives 210, the metadata storage 212 and/or the user profile storage 408 may be stored across multiple storage mediums depending on desired design criteria.

The television receiving resource 402 is operable to receive content 202 from the content source 102 (see FIG. 1) and coordinate the storage of the content 202 onto the content archives 210. In at least one embodiment, the television receiving resource 402 comprises a communication network interface (e.g., Ethernet or the like) configured to receive the content 202 over a local area network (LAN) or wide area network (WAN).

The content 202 may comprise one or more linear channels of content. For example, a satellite provider may distribute hundreds of channels across the television distribution system 100. Each linear channel may be received at an uplink center of the satellite provider. As the channels received by the satellite provider are prepared for transmission to the satellite, the content 202 may be simultaneously transmitted from the uplink center into the television receiving resource 402 for storage into the content archives.

In at least one embodiment, the television receiving resource 402 receives and coordinates the storage of each program for one or more specified channels onto the content archives 210. In other words, the television receiving resource 402 stores the entire programming broadcast of the channel. However, the television receiving resource 402 may also be configured to receive and coordinate the recording of a subset of received programming onto the content archives 210. For example, the television receiving resource 402 may receive and coordinate the storage of user selected programming and/or operator selected programming. For example, a satellite television provider or cable television provider may desire to store top ranked programming onto the content archives 210 and/or programming for which they have to redistribute over the Internet, depending on desired design criteria.

The control logic 404 is operable to control the operation of the content storage server 110A. The control logic 404 may be a single processing device or a plurality of processing devices that cooperatively operate to control the operation of the DVR 106A. The control logic 306 may include various components or modules for processing and outputting audio/video content. Exemplary components or modules for processing audio/video content include a demodulator, a decoder, a decompressor, a conditional access module and a transcoder module.

In other embodiments, the control logic 404 is operable to perform the reformatting and translation previously described with reference to FIG. 2. In such embodiments, the control logic 404 contains the logic necessary to perform file format translation, content translation, encryption, compression, etc.

In at least one embodiment, the content storage server 110A may comprise a plurality of like hardware units which cooperatively operate to process requests from multiple users simultaneously. In other words, the content storage server 110A may comprise a server farm that distributes client requests across a plurality of servers in a balanced fashion.

The control logic 404 processes client requests to access content in the content archives 210 and coordinates the distribution of content 204 to individual communication devices 114 (see FIG. 1). The control logic 404 also processes metadata 206 and 208 received from communication device 114 and/or DVR 106 to update the metadata storage 212. For example, the metadata 206 may indicate that the DVR 106 has recorded new content, deleted old content, set new recording timers and the like.

The control logic 404 utilizes the metadata storage 212 to track which of the content in the content archives 210 that a particular user is entitled to access. Through the metadata 206 and 208 received by the content storage server 110A, the control logic 404 is able to synchronize a virtual image of the DVR 106 maintained by the content storage server 110A.

The user profile storage 408 stores profile information relating to users that are entitled to access the content storage server 110A. For example, the user profile storage 408 may store authentication information, such that the control logic 404 can verify that login credentials provided by a particular communication device 114 are correct. The user profiles storage 408 may also store information linking particular communication devices 114 to a particular DVR 106 and/or corresponding metadata stored in the metadata storage 212.

The network interface 406 is operable to communicate with the DVR 106 and/or the communication device 114 through the communication network 112. The network interface 406 receives various information from the aforementioned devices, including metadata 206, metadata 208, and requests to access content. For example, the communication device 114 may transmit a request to access content in the content archives. The network interface 406 receives the requests and transmits the same to the control logic 404 for processing.

For example, the communication device 114 may initially connect to the content storage server 110A and request to view a list of available content. The control logic 404 authenticates the request and processes metadata in the metadata storage 212 to identify content available to the user of the communication device 114. In at least one embodiment, the control logic 404 processes metadata to identify what programming the user of the communication device 114 has stored on their associated DVR 106. The control logic 404 thus allows the user to access that programming which is available on the DVR 106.

Take for example, the situation where the content archives 210 stores the programs illustrated in Table #1. As illustrated in Table #1, the content archives 210 includes ten programs recorded at various times on various channels.

TABLE #1
Programs Stored in Content Archives 210

| Program | Channel | Date Recorded |
|---|---|---|
| Simpsons | 2 | Jul. 14, 2009 7:00 P.M. |
| Simpsons | 2 | Jul. 15, 2009 7:00 P.M. |
| Lost | 3 | Jul. 07, 2009 8:00 P.M. |
| Lost | 3 | Jul. 14, 2009 8:00 P.M. |
| Evening News | 2 | Jul. 13, 2009 10:00 P.M. |
| Evening News | 2 | Jul. 14, 2009 10:00 P.M. |
| Evening News | 2 | Jul. 15, 2009 10:00 P.M. |
| Sports Center | 4 | Jul. 15, 2009 9:00 A.M. |
| Sports Center | 4 | Jul. 15, 2009 10:00 A.M. |
| Sports Center | 4 | Jul. 15, 2009 11:00 A.M. |

Now, take for example the situation where the DVR 106 (see FIG. 1) includes the stored programs illustrated in Table #2. As illustrated in Table #2, there are three programs stored on the DVR 106. The three programs comprise a subset of the programs stored by the content archives 210 in Table #1.

TABLE #2
Programs Stored on DVR 106

| Program | Channel | Date Recorded |
|---|---|---|
| Simpsons | 2 | Jul. 14, 2009 7:00 P.M. |
| Evening News | 2 | Jul. 15, 2009 10:00 P.M. |
| Sports Center | 4 | Jul. 15, 2009 11:00 A.M. |

The metadata storage 212 stores data identifying the programs stored on the DVR 106. Thus, responsive to a request from the communication device 114, the control logic 404 processes the metadata storage 212 and identifies the programs illustrated in Table #2 which a user of the communication device 114 is entitled to access based on the content stored on their DVR 106. The control logic 404 then initiates transmission of the list illustrated in Table #2 to the communication device 114, via the network interface 406.

The user of the communication device 114 may then request to view any of the programs illustrated in Table #2. The control logic 404 coordinates the retrieval of the requested program and the transmission of the content 204 to the communication device 114 via the network interface 406. Thus, the user may access content stored on their DVR 106 without actually accessing and streaming the content from the DVR 106 to the communication device 114. Rather, the content storage server 110A stores a virtual image of the DVR 106 and allows the user to access any of the content of virtual image of the DVR 106 from the content archives 210.

However, the user is not entitled to access content in the content archives 210 for which they do not have the requisite rights. In one embodiment, the user does not have rights to content which is not stored on their personal DVR 106. However, in other embodiments, the user may have the right to delete content from the DVR 106 while still retaining the right to access the deleted content from the content storage server 110A. For example, the user may pay a fee to “store” content on the content storage server 110A, i.e., access content which they have previously deleted from the personal DVR 106. In other embodiments, a user may be able to access content for which they previously recorded using their DVR. For example, a user may be able to pay a fee to purchase the right to view content stored in the content archives 210 for which they did not previously record.

In at least one embodiment, the metadata stored in the metadata storage 212 may be utilized to reconstruct a failed DVR 106. For example, if the user's DVR 106 fails, then they could connect to the content storage server 110A to download metadata identifying what content they are entitled to access and additionally download the content onto the storage medium of their DVR 106. Also, as described above, a user may pay for the right to delete content from the DVR 106 but still access the content via the content storage server 110A. In at least one embodiment, the user may have the option of downloading the content from the content storage server 110A and storing the downloaded content onto the DVR 106, depending on desired design criteria.

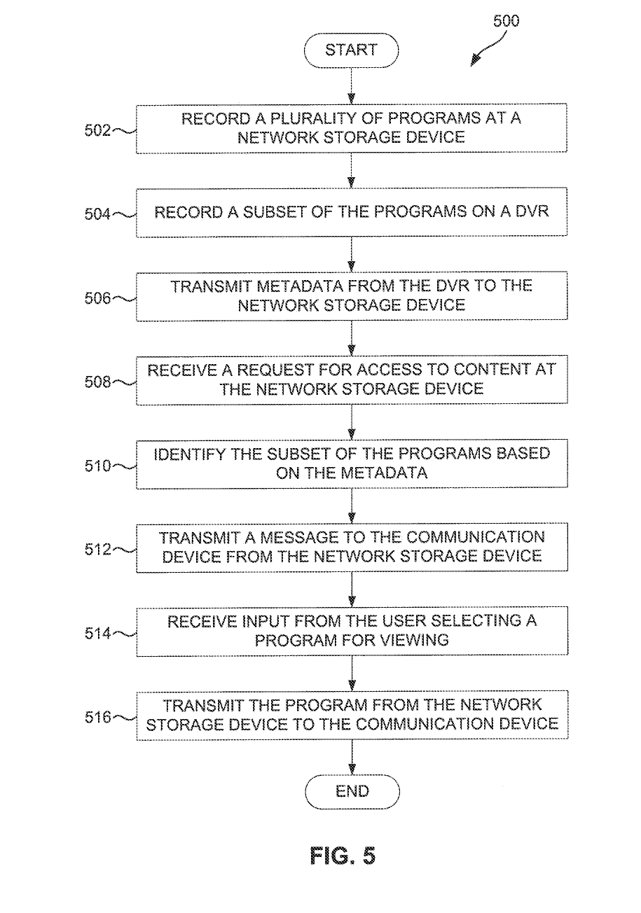

FIG. 5 illustrates an embodiment of a process 500 for controlling access to stored content. More particularly, FIG. 5 illustrates an embodiment of a process for allowing a user to remotely access content stored on their DVR from a server remotely located with respect to the DVR. The process of FIG. 5 may include other operations not illustrated for brevity.

The process includes recording a plurality of programs at a network storage device (operation 502). The network storage device may be located remotely with respect to the DVR. The process includes further recording a subset of the programs on a DVR (operation 504). In at least one embodiment, portions of operation 504 are performed simultaneously with portions of operation 502. In other words, the network storage device and the DVR may record the same portions of content at the same time.

The process further includes transmitting metadata from the DVR to the network storage device, the metadata identifying the programs stored on the DVR (operation 506). In other words, the metadata may include information identifying the subset of programs. The metadata may also include other programs stored by the DVR as well as other data, such as bookmarks, associated with the subset of the programs.

The process further includes receiving a request, at the network storage device, from a communication device, for access to a user's content (operation 508). For example, a user may utilize an application operating on a mobile telephone or computer to request access to their content via the network storage device. In some embodiments, the request to the network storage device may come via a web page accessed through a standard web browser or the like.

Responsive to the request, the process includes identifying the subset of the programs that the user is entitled to access based on the metadata (operation 510). The process further includes transmitting a message from the network storage device to the communication device, the message identifying the subset of the programs (operation 512). The communication device presents a list of the subset of programs to a user and solicits input from the user to select a program for viewing (operation 514). Responsive to the input, the process includes transmitting the selected program from the network storage device to the communication device for presentation to a user (operation 516).

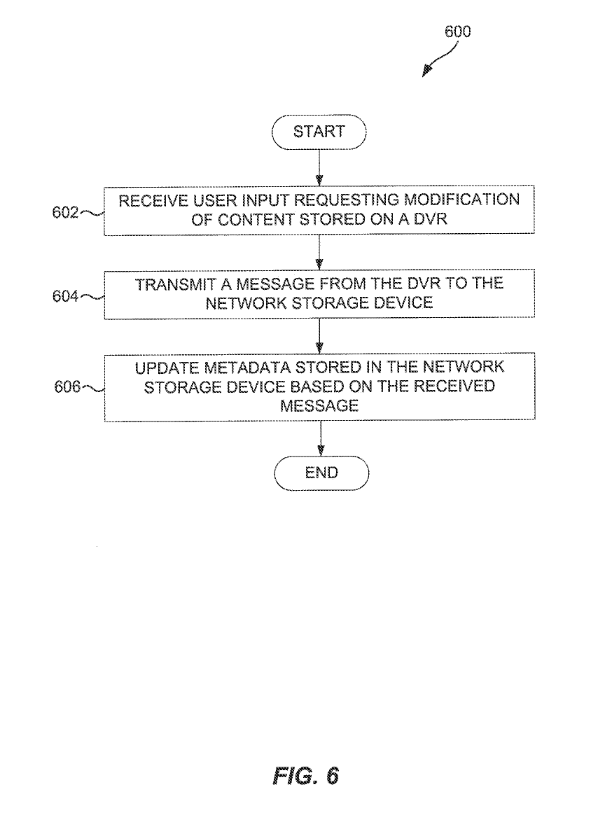

FIG. 6 illustrates an embodiment of a process 600 for synchronizing metadata between a network storage device and a DVR. The process of FIG. 6 may be utilized to synchronize data at a DVR based on input received at a network storage device or to synchronize data at a network storage device based on input received at the DVR depending on desired design criteria. However, the process will be described in the context of updating metadata based on input received at a DVR. The process of FIG. 6 may include other operations not illustrated for the sake of brevity.

The process includes receiving user input requesting modification of content stored on the DVR (operation 602). For example, a user may request to delete a stored recording. A user may also request to add a new recording timer, edit a recording timer, edit a description of content stored on the DVR, add a bookmark to stored content or the like. In at least one embodiment, operation 602 may alternatively comprise recording content at a DVR responsive to a recording timer or other input of the user.

The process further includes transmitting a message, responsive to the input in operation 602, from the DVR to the network storage device (operation 604). For example, the message may indicate that a user deleted a recording from their DVR. In at least one embodiment, the message is transmitted from the DVR to the network storage device in substantially real-time after the input is processed by the DVR. In other words, the DVR receives the input from the user in operation 602, identifies an action to be taken responsive to the input, undertakes the action and then initiates transmission of the message in operation 604.

The process further includes updating metadata stored in the network storage device based on the received message (operation 606). Thus, the network storage device and the DVR stay synchronized in real-time, such that when a user accesses the network storage device using a communication device, they see the same content that is available on the DVR 106.

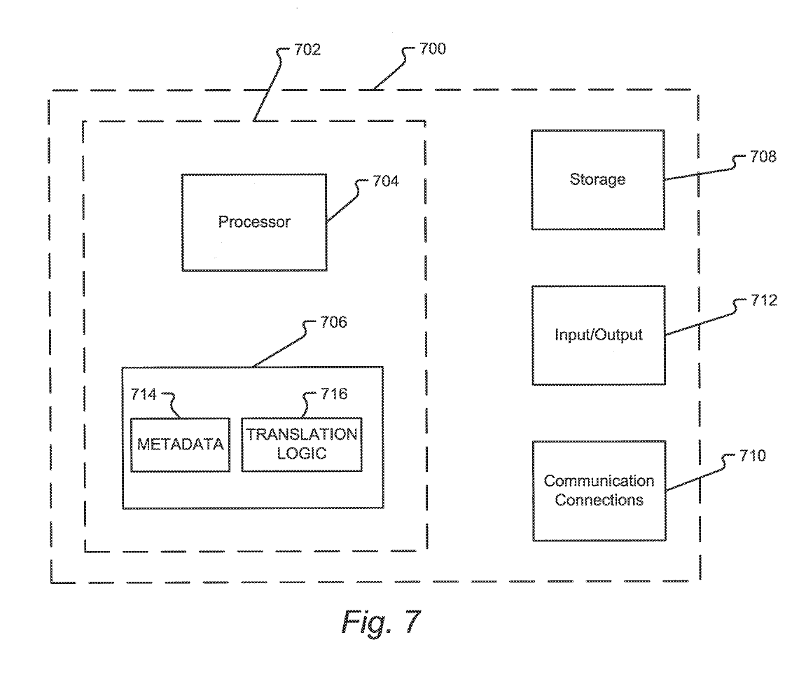

With reference to FIG. 7, an embodiment of a computing environment for implementing the various embodiments described herein includes a computer system, such as computer system 700. Any and all components of the described embodiments (such as the DVR, the content storage sever, a laptop, mobile device, personal computer, etc.) may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 700 comprises at least one processing unit or processor 704 and system memory 706. The most basic configuration of the computer system 700 is illustrated in FIG. 7 by dashed line 702. In some embodiments, one or more components of the described system are loaded into system memory 706 and executed by the processing unit 704 from system memory 706. Depending on the exact configuration and type of computer system 700, system memory 706 may be volatile (such as RAM), non-volatile (such as ROM, flash memory, etc.), or some combination of the two.

Additionally, computer system 700 may also have additional features/functionality. For example, computer system 700 may include additional storage media 708, such as removable and/or non-removable storage, including, but not limited to, magnetic or optical disks or tape. In some embodiments, software or executable code and any data used for the described system is permanently stored in storage media 708. Storage media 708 includes volatile and non-volatile, removable and non-removable media implemented in any method or technology for storage of information such as computer readable instructions, data structures, program modules, or other data.

System memory 706 and storage media 708 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information and which is accessed by computer system 700 and processor 704. Any such computer storage media may be part of computer system 700. In some embodiments, system memory 706 and/or storage media 708 may store data used to perform the methods or form the system(s) disclosed herein, such as the content and the metadata described herein. In other embodiments, system memory 706 may store information such as metadata 714 and translation logic 716.

Computer system 700 may also contain communications connection(s) 710 that allow the device to communicate with other devices. Communication connection(s) 710 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, content and metadata may be transmitted over communications connection(s) 710.

In some embodiments, computer system 700 also includes input and output connections 712, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 712 are used to display the information as described herein. All these devices are well known in the art and need not be discussed at length here.

In some embodiments, the component described herein comprise such modules or instructions executable by computer system 700 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 700 is part of a network that stores data in remote storage media for use by the computer system 700.

This disclosure described some embodiments of the present invention with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although specific embodiments were described herein, the scope of the invention is not limited to those specific embodiments. One skilled in the art will recognize other embodiments or improvements that are within the scope and spirit of the present invention. Therefore, the specific structure, acts, or media are disclosed only as illustrative embodiments. The scope of the invention is defined by the following claims and any equivalents therein.

What is claimed is:

1. A system comprising:
a digital video recording (DVR) device operable to:
receive content;
store a portion of the received content; and
generate metadata identifying the portion of the received content stored on the DVR device; and
a content storage server in communication with the DVR device, the content storage server operable to:
receive the content;
store the received content;
receive the metadata from the DVR device;
receive a request for access to the content from a communication device;
identify a portion of the content that the communication device is entitled to access based on at least the received metadata; and
transmit the portion of the content to the communication device for presentation to a user.

2. The system of claim 1, wherein the content storage server is further operable to:
translate the portion of the content before transmitting the portion of the content to the communication device.

3. The system of claim 2, wherein the translation comprises translating a content format of the portion of the content.

4. The system of claim 2, wherein the translation comprises translating a compression format of the portion of the content.

5. The system of claim 2, wherein the content storage server is further operable to:
determine a format supported by the communication device before translating the portion of the content.

6. The system of claim 1, wherein the metadata comprises at least one of:
a bookmark;
a program name;
a program identifier;
a program description;
an event id used in timers;
an event id used in spontaneous recordings;
an event id of deleted events;
control information;
location information; and
personalization data.

7. The system of claim 1, wherein the DVR device sends the metadata to the content storage server in real-time.

8. The system of claim 1, wherein the DVR device sends the metadata to the content storage server at a pre-determined time or interval.

9. The system of claim 1, wherein the content storage server is further operable to:
create a virtual image of the DVR device, wherein the virtual image is created based upon the metadata received from the device.

10. The system of claim 9, wherein the content storage server determines that the communication device is entitled to access the requested content if the requested content is within the subset of the content identified by the virtual image of the DVR device.

11. A system for presenting content to a communication device, the system comprising:
a content storage server operable to:
receive content;
store the received content;
receive metadata from a digital video recorder (DVR) device;
receive a request, from the communication device, for access to the content stored on the content storage server;
determine if the communication device is entitled to the requested content based at least on the received metadata; and
if the communication device is entitled to the requested content, transmit at least a portion of the content to the communication device.

12. The system of claim 11, wherein the content storage server stores all received content.

13. The system of claim 11, wherein the content storage server stores content if it receives metadata indicating that a user intends to record the content.

14. The system of claim 11, wherein the content storage server is further operable to:
perform a translation on the portion of the content before transmitting the portion of the content to the communication device.

15. The system of claim 13, wherein the type of translation performed depends upon access rights determined from the metadata.

16. A method of managing content at a content storage server, the method comprising:
receiving metadata from a DVR device, the metadata indicating that a user intends to record content received at the DVR device;
receiving content at the content storage server;
storing the received content at the content storage server if the metadata indicates that the user intends to record the content received at the DVR device;
receiving a request, from a communication device, for access to the content stored on the content storage server;
determining if the communication device is entitled to the requested content, wherein the determination is based at least upon the metadata received from the DVR device; and
if the communication device is entitled to the requested content, transmitting at least a portion of the content to the communication device.

17. The method of claim 16, further comprising:
performing a translation on at least a portion of the content to be transmitted to the communication device.

18. The method of claim 16, wherein the content storage server stores a copy of the content stored on the DVR device.

19. The method of claim 16, wherein the content storage server stores a global copy of the content, the global copy of the content comprising a copy of the content that is accessible by more than one user.

20. The method of claim 19, further comprising:
creating a logical copy of the content based at least upon the metadata, wherein the logical copy of the content is associated with a user profile and provides a pointer or reference to the global copy of the content.
